(19) United States
(12) Patent Application Publication
(10) Pub. No.: US 2017/0365012 A1
(43) Pub. Date: Dec. 21, 2017

(54) IDENTIFYING SERVICE PROVIDERS AS FREELANCE MARKET PARTICIPANTS

(71) Applicant: LinkedIn Corporation, Mountain View, CA (US)

(72) Inventors: Onkar Anant Dalal, Santa Clara, CA (US); Vaibhav Goel, Mountain View, CA (US); Yiran Pang, Palo Alto, CA (US); Ruslan Zagatskiy, San Francisco, CA (US)

(21) Appl. No.: 15/188,665

(22) Filed: Jun. 21, 2016

(51) Int. Cl. G06Q 50/00; G06Q 30/06

(52) U.S. Cl. CPC G06Q 50/01; G06Q 30/0623

(57) ABSTRACT

A system, a machine-readable storage medium storing instructions, and a computer-implemented method are described herein for a Classification Engine for identifying, according to encoded rules of a plurality of service models, at least one type of service offered by a target member account of a social network service. The Classification Engine classifies, according to encoded rules of a freelancer inference model, the target member account as a freelancer account. The Classification Engine sends an invitation to the freelancer account to join a freelance marketplace within the social network service. The freelance marketplace includes various consumer accounts requesting to purchase a performance various types of services and specialties.

### TECHNICAL FIELD

The present disclosure generally relates to data processing systems. More specifically, the present disclosure relates to methods, systems and computer program products for classifying member accounts in a social network service.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”, as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram showing the functional components of a social networking service, according to various embodiments;

FIG. 2 is a block diagram of an example system, according to various embodiments;

FIG. 3 is a flowchart illustrating an example method, according to various embodiments;

FIG. 4 illustrates a data flow diagram of a Classification Engine assembling feature vectors for a plurality of service models to infer a service provided by a target member account, according to various embodiments;

FIG. 5 illustrates a data flow diagram of a Classification Engine assembling a feature vector for a freelancer inference model to classify the target member account as a freelancer account, according to various embodiments;

FIG. 6 is a block diagram showing example components of a Classification Engine, according to some embodiments;

FIG. 7 is a diagrammatic representation of a machine in the example form of a computer system within which a set of instructions, for causing the machine to perform any one or more of the methodologies discussed herein, may be executed according to various embodiments.

### DETAILED DESCRIPTION

The present disclosure describes methods and systems for classifying a member account in a social network service. In the following description, for purposes of explanation, numerous specific details are set forth in order to provide a thorough understanding of the various aspects of different embodiments described herein. It will be evident, however, to one skilled in the art, that various embodiments may be practiced without all of the specific details.

A system, a machine-readable storage medium storing instructions, and a computer-implemented method are described herein for a Classification Engine for identifying, according to at least one encoded rule of each service model from plurality of service models, at least one type of service offered by a target member account(s) of a social network service. The Classification Engine classifies, according to at least one encoded rule of a freelancer inference model, the target member account(s) as a freelancer account. The Classification Engine sends an invitation to the freelancer account(s) to join a freelance marketplace within the social network service. The freelance marketplace includes various consumer accounts requesting to purchase a performance of various types of services and specialties from respective freelancer accounts that have joined the freelance marketplace.

According to various exemplary embodiments, the Classification Engine processes raw profile data of various member accounts of a social network service in order to infer what type of service(s) each member account performs and to infer whether each member account is a freelancer. If the Classification Engine classifies a particular member account as a freelancer account that provides a particular type of service(s), the Classification Engine generates an invitation for the freelancer account. The invitation provides a selectable functionality the freelancer account can select to initiate registration for a freelance marketplace in which the freelancer account can engage in transactions with various consumer accounts seeking proposals for the type of service(s) offered by the freelancer account.

The Classification Engine utilizes a plurality of regression models to identify a type of service(s) provided by a user represented by a member account. For example, the Classification Engine utilizes 30 different regression service models for 30 services, where a respective regression model directly corresponds to a particular service. The Classification Engine can also apply the plurality of regression models to further identify the member account's speciality within a particular type of service as well as one or more skills. Each type of service is associated with a distinct regression model. For example, the Classification Engine identifies features for a plurality of service models from raw data of the target member account to infer the services most likely offered by the target member account and the specialties most likely associated with the target member account. It is understood that each respective service model has a unique, pre-determined set of features

In addition to identifying the type of service(s) offered by the user represented by the target member account, the Classification Engine further utilizes another regression model to determine whether the user represented by the member account provides the inferred services on a freelance basis—as opposed to being a full-time employee. For example, the Classification Engine identifies features for a freelancer inference model from raw data of the target member account to infer whether the target member account provides service on freelance basis. It is understood that the freelancer inference model has a pre-determined set of features that is different than the features of the various service models. It is understood that a pre-defined feature(s) is identified—during a model training process—as an attribute(s) and/or a portion of raw data that is germane in making a prediction or an inference.

Upon classifying the target member account as a freelancer account that offers a type of service(s), the Classification Engine sends an invitation to the freelancer account to join a freelance marketplace within the social network service. The freelance marketplace is a commercial portal within the social network service that allows consumer accounts of the social network service to request various type of services from service provider accounts of the social network service. For example, a consumer account selects a type of desired service and one or more service requirements. Service provider accounts that offer the type of desired service are notified and prompted to submit a proposal of services to the consumer account. By identifying freelancer accounts and sending invitations to join the freelance marketplace, the Classification Engine increases the likelihood that the freelance marketplace is populated with service provider accounts offering a wide variety of services.

In various embodiments, each distinct service model and the freelancer inference model are built, trained and implemented according to one of various known prediction modeling techniques. Training data is used to train each service model and the freelancer inference model. The training process identifies the features of each model. To build and train each service model and the freelancer inference model, the Classification Engine may perform a prediction modeling process based on a statistics-based machine learning model such as a logistic regression model. Other prediction modeling techniques may include other machine learning models such as a Naive Bayes model, a support vector machines (SVM) model, a decision trees model, and a neural network model, all of which are understood by those skilled in the art.

According to various exemplary embodiments, the Classification Engine may be executed for the purposes of both off-line training (for generating, training, and refining the prediction model) and online identifications of types of services and specialties and freelancer classifications.

According to various exemplary embodiments, the Classification Engine may be used for the purposes of both off-line training of a plurality of regression models as well as online service identifications, specialty identifications, skills identifications and freelancer classifications. As described in various embodiments, the Classification Engine may be a configuration-driven system for building, training, and deploying models for classifying member accounts as freelancer accounts providing various inferred services, specialties and skills. In particular, the operation of the Classification Engine is completely configurable and customizable by a user through a user-supplied configuration file such as a JavaScript Object Notation (JSON), eXtensible Markup Language (XML) file, etc.

For example, each module in the Classification Engine may have text associated with it in a configuration file(s) that describes how the module is configured, the inputs to the module, the operations to be performed by the module on the inputs, the outputs from the module, and so on. Accordingly, the user may rearrange the way these modules are connected together as well as the rules that the various modules use to perform various operations. Thus, whereas conventional prediction modeling is often performed in a fairly ad hoc and code driven manner, the modules of the Classification Engine may be configured in a modular and reusable fashion, to enable more efficient identification and classification.

It is understood that various embodiments further include encoded instructions that comprise operations to generate a user interface(s) and various user interface elements. The user interface and the various user interface elements can be displayed to be representative of any of the operations, data, models, classifications, services, specialties, features, accounts and invitations, as described herein. In addition, the user interface and various user interface elements are generated by the Classification Engine for display on a computing device, a server computing device, a mobile computing device, etc.

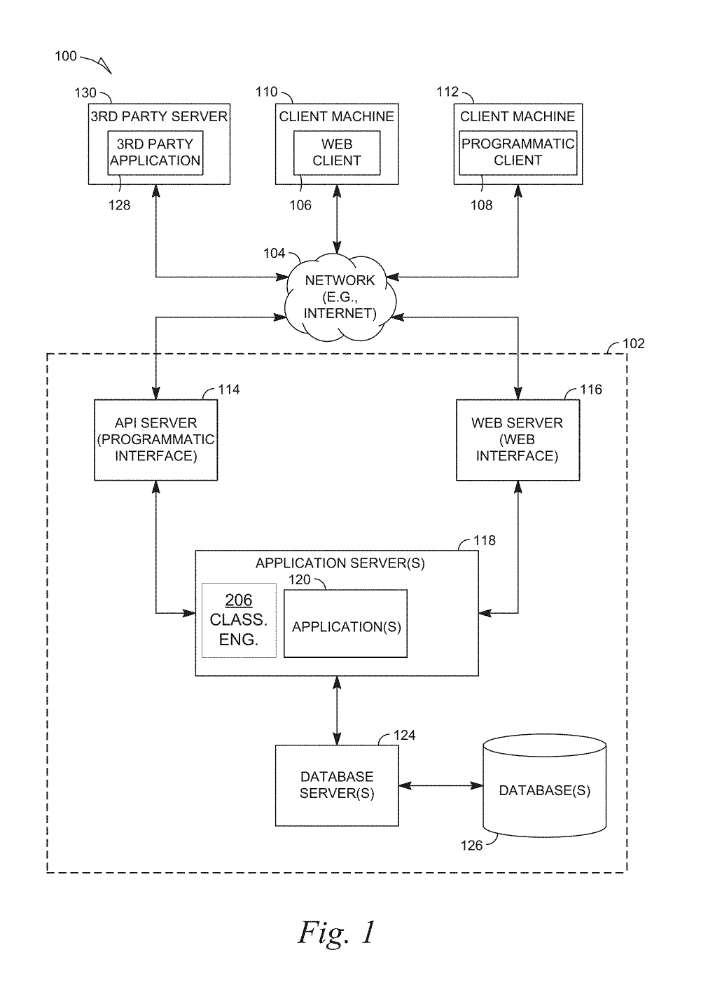

Turning now to FIG. 1, FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102. In some embodiments, the application servers 118 include Classification Engine 206. However, it is understood that the Classification Engine 206 can be implemented by any component(s) of system 102. It is also understood a portion of the Classification Engine 206 can be implemented by any component(s) of system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

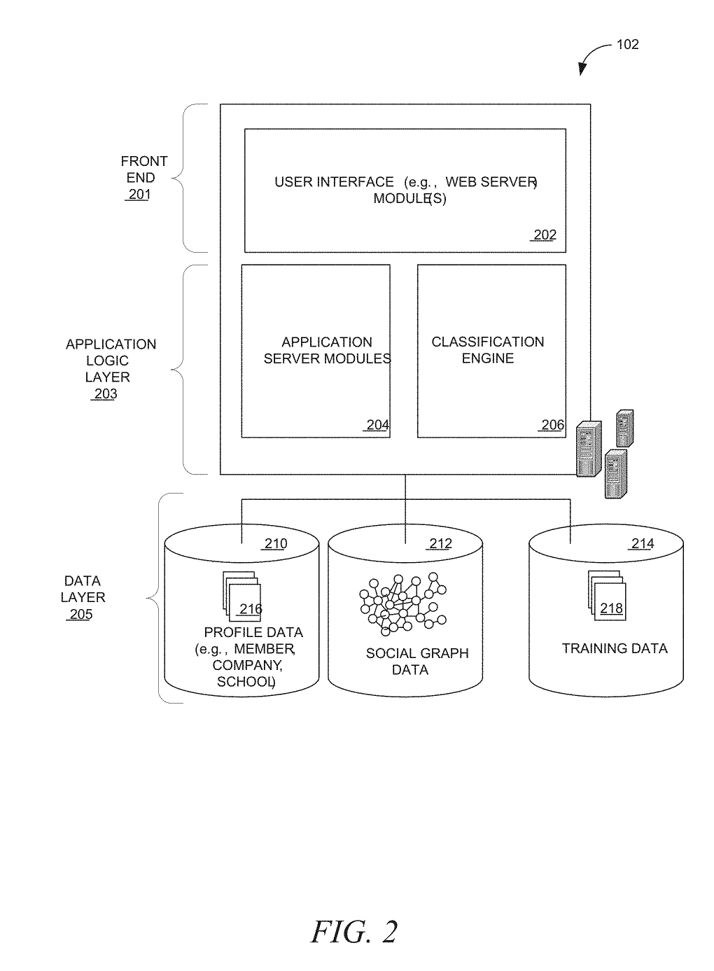

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or Systems shown in FIG. 2 represent a set of executable software instructions and the corresponding hardware (e.g., memory and processor) for executing the instructions. To avoid obscuring the inventive subject matter with unnecessary detail, various functional modules and systems that are not germane to conveying an understanding of the inventive subject matter have been omitted from FIG. 2. However, one skilled in the art will readily recognize that various additional functional modules and systems may be used with a professional social network, such as that illustrated in FIG. 2, to facilitate additional functionality that is not specifically described herein. Furthermore, the various functional modules and systems depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface modules) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and. organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes allowed to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

As members interact with the various applications, services and content made available via the professional social network, the members' behaviour (e.g., content viewed, links or member-interest buttons selected, etc.) may be monitored and information 218 concerning the member's activities and behaviour may be stored, for example, as indicated in FIG. 2, by the database 214. This information 218 can be training data. Database 214 can also include different types of training data that includes in part raw data and profile attributes of various freelancer accounts and raw data and profile attributes of various member accounts that provide one or more types of services.

In some embodiments, the professional social network provides an application programming interface (API) module via which third-party applications can access various services and data provided by the professional social network. For example, using an APE a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

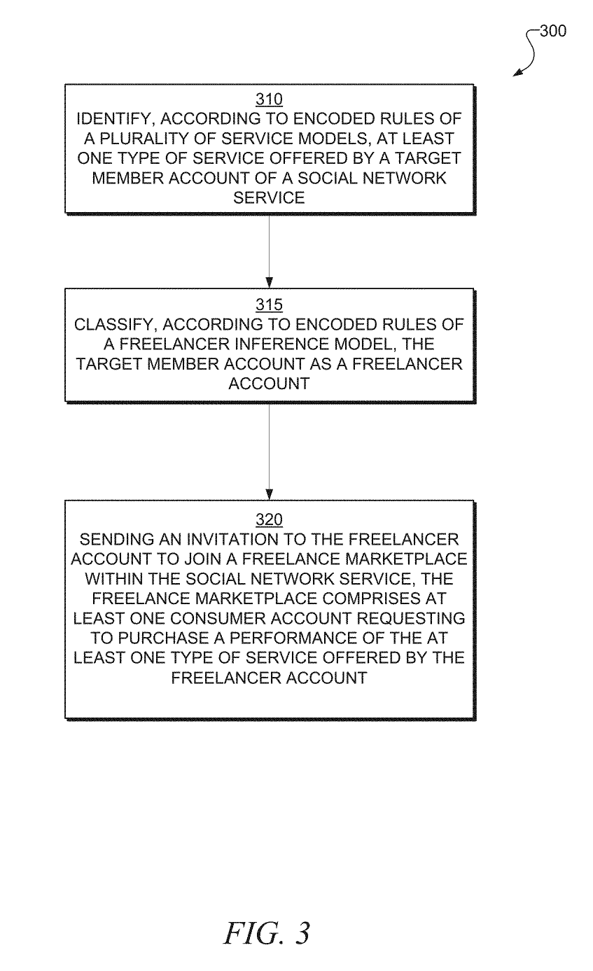

The data in the data layer 205 may be accessed, used, and adjusted by the Classification Engine 206 as will be described in more detail below in conjunction with FIGS. 3-8. Although the Classification Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure. It is understood that the Classification Engine 206 can be implemented in one or more of the application servers 118.

FIG. 3 is a flowchart 300 illustrating an example method 300, according to various embodiments.

At operation 310, the Classification Engine 206 identifying, according to encoded rules of a plurality of service models, a type of service(s) offered by a target member account of a social network service. The Classification Engine 206 utilizes a service model for each type of service that any given member account can offer. Each service model includes a distinct set of encoded rules and a set of pre-defined features for converting a member account's raw data and attributes into feature vector data.

The Classification Engine 206 assembles feature vector data in order for the respective service model to calculate an output representing a probability that the target member account offers the respective service. For example—for each service model—the Classification Engine 206 accesses encoded data representative of a feature rule for a type of pre-defined feature. The Classification Engine 206 accesses encoded data representative of an attribute(s) of the target member account that corresponds with the type of the pre-defined feature. The Classification Engine 206 identifies a learned coefficient associated with the type of the pre-defined feature. The Classification Engine 206 assembles, according to the feature rule, a portion of feature vector data for the target member account based on the attribute(s) and raw data of the target member account and the learned coefficient associated with the type of the pre-defined feature.

Each service model calculates a probability score for a respective service. The Classification Engine 206 compares a threshold score to a service model's probability score. If the threshold score is met or exceeded, the Classification Engine 206 infers that the target member account most likely provides the service represented by that service model. In various embodiments, each service model is associated with a unique threshold score. In an alternative embodiment, the Classification Engine 206 ranks the probability scores calculated by each service model. The Classification Engine 206 selects a pre-defined portion of the ranked score, such as the three highest ranked score or the top 10% scores. The Classification Engine 206 identifies that each selected ranked score corresponds with a service that is provided by the target member account.

At operation 315, the Classification Engine 206 classifies, according to encoded rules of a freelancer inference model, the target member account as a freelancer account. The Classification Engine 206 assembles feature vector data in order for the freelancer inference model to calculate an output representing a probability that the target member account provides service on a freelance basis. The Classification Engine 206 assembles feature vector data for the freelancer inference model in a similar manner as described above in connection with operation 310. In addition, the freelancer inference model calculates a probability score for the freelancer inference model. The Classification Engine 206 compares the probability score to a threshold score. If the probability score calculated by the freelancer inference model meets or exceeds the threshold score, the Classification Engine 206 infers that the target member account is a freelancer account.

According to various embodiments, it is understood that each service model and the freelancer inference model are logistic regression models. As understood by those skilled in the art, logistic regression is an example of a statistics-based machine learning technique that uses a logistic function. The logistic function is based on a variable, referred to as a logit. The logit is defined in terms of a set of regression coefficients of corresponding independent predictor variables. Logistic regression can be used to predict the probability of occurrence of an event (or action) given a set of independent/predictor variables.

The independent/predictor variables of each service model and the freelancer inference model are the attributes represented by assembled feature vectors based on the types of features described throughout. Regression coefficients for each type of feature may be estimated using maximum likelihood or learned through a supervised learning technique from data collected in logged training data or calculated from log data describing data and attributes that correspond to services, skills and specialities, as well as describing data and attribute that correspond with a freelancer account.

Accordingly, once the appropriate regression coefficients (e.g., A) are determined, the features are inserted into various data locations in order to assemble a respective feature vector for each service model and the freelancer inference model. A first feature vector may be input into a first service model in order to calculate a probability that the target member account provides a first service. A second feature vector may be input into a second service model in order to calculate a probability that the target member account provides a second service. A third feature vector may be input into the freelancer inference model in order to calculate a probability that the target member account is associated with a user that provides a service on a freelance basis. Stated differently, an assembled feature vector for the target member account is based on various types of feature rules and regression feature coefficients of each model. The features are based on raw account data and member account attributes.

At operation 320, the Classification Engine 206 sends an invitation to the freelancer account to join a freelance marketplace within the social network service. The freelance marketplace is a commercial portal with the social network service that serves as a platform for transactions between freelancer accounts and consumer accounts to purchase a performance of services. In various embodiments, the Classification Engine 206 generates and sends a message to the target member account. The message includes selectable functionalities for the target member account to select in order to initiate registration in the freelance marketplace

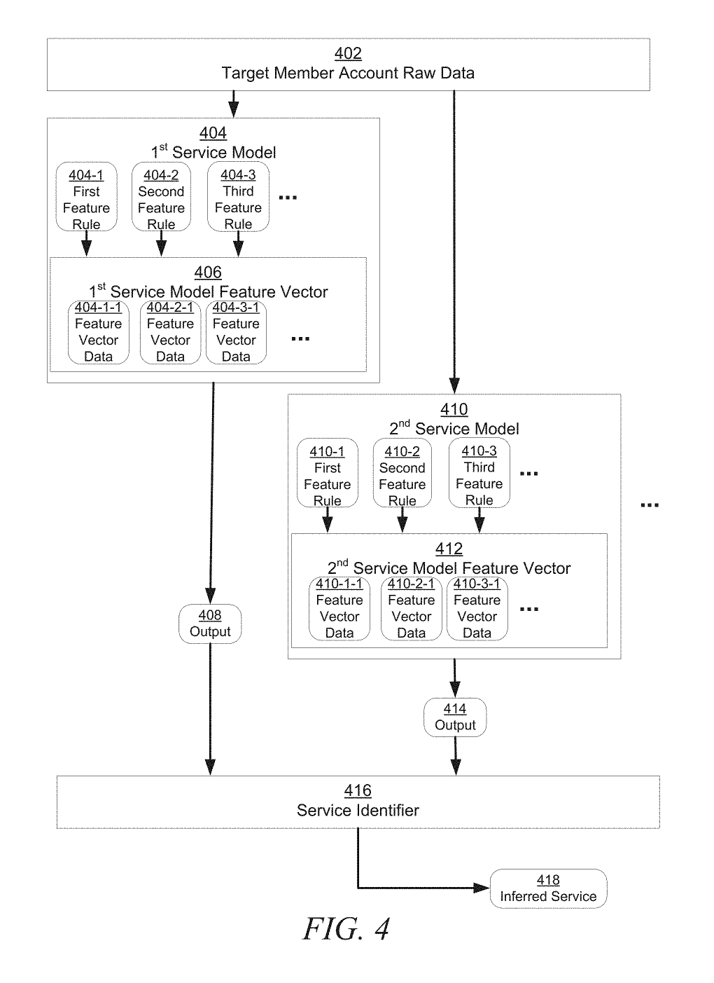

FIG. 4 illustrates a data flow diagram of a Classification Engine 206 assembling feature vectors 406, 412 . . . for a plurality of service models 404, 410 . . . to infer a service provided by a target member account, according to various embodiments.

As illustrated in FIG, 4 Classification Engine 206 includes a plurality of service models 404, 410 . . . . In order to determine a type of service offered by the target member account, Classification Engine 206 utilizes features of a plurality of distinct service models 404, 410 . . . . The Classification Engine 206 extracts raw data 402 from one or more sections of a target member account's profile. The raw data 402 also includes the target member account's browsing activities within the social network service, transaction history and social graph. The Classification Engine 206 assembles a feature vector 406, 412 . . . for each service model 404, 410 . . . based on the respective encoded service model rules 404-1, 404-2, 404-3_, 410-1, 410-2, 410-3 . . . and extracted raw data. Each service model 404, 410 . . . is utilized by the Classification Engine 206 to infer whether a user represented by the target member account offers a particular service or has a particular speciality or skill.. For example, the Classification Engine 206 utilizes a first service model 404 to infer whether the target member account offers a Software Development service and a second service model 4120 to infer whether the target member account offers a Graphic Design service. The first service model 404 and the second service model 410 each have their own set of different encoded service model rules 404-1, 404-2, 404-3, 410-1, 410-2, 410-3 . . . based on various pre-defined features.

The Classification Engine 206 extracts raw data for each encoded service model rules 404-1, 404-2, 404-3 . . . , 410-1, 410-2, 410-3 . . . . Each service model rule 404-1, 404-2, 404-3 . . . , 410-1, 410-2, 410-3 . . . transforms a portion of raw data into feature vector data 404-1-1, 404-2-1, 404-3-1 . . . , 410-1-1, 410-2-1, 410-3-1 . . . . The Classification Engine 206 assembles a feature vector 406 for the first service model 404 by inserting feature vector data 404-1-1, 404-2-1, 404-3-1 . . . at pre-defined vector data positions. The Classification Engine 206 assembles a feature vector 412 for second service model 410 by inserting feature vector data. 410-1-1, 410-2-1, 410-3-1 . . . at pre-defined feature vector data positions.

In addition, each service model 404, 410 has been trained according to identify one or more keywords that are germane in predicting whether a given member account most likely offers a certain type of service. As such, the first service model 404 includes keyword feature rules based on keywords identified as being highly associated with the first service. In addition, the second service model 410 includes keyword feature rules based on keywords identified as being highly associated with the second service. For example, a Software Development service model has learned from training data that certain keywords tend to appear throughout various sections of profiles of member accounts that provide Software Development services. In addition, a Graphic Design service model has learned from the training data that certain different keywords tend to appear throughout various sections of profiles of member accounts that provide Graphic Design services. The Classification Engine 206 creates various encoded feature rules based on the keywords for each service model 404, 410 . . . .

The Classification Engine 206 assembles feature vectors 406, 412 . . . for each service model 404, 410 . . . . For the first service model 404, the Classification Engine 206 extracts portions of raw data that correspond with the feature rules 404-1, 404-2, 404-3 . . . of the first service model. For example, a feature rule corresponds to a keyword in a particular profile section. The Classification Engine 206 accesses the raw data 402 and extracts text for the particular section of the target member account's profile. The Classification Engine 206 transforms the extracted text according to the feature rule to generate feature vector data. The Classification Engine 206 inserts the feature vector data in a feature vector position for the feature rule.

In one embodiment, the first service model 404 and the second service model 410 can include an encoded feature rule for the same type of pre-defined feature, but have different regression coefficients that corresponds with the feature rule. In another embodiment, the first service model 404 includes a feature rule for a type of pre-defined feature that differs from any feature in the second service model 410.

Various type of pre-defined features are represented according to feature rules. Each feature rule has a corresponding regression coefficient. Pre-defined features can be various profile text type features. A profile text type feature can also be a text similarity feature and a keyword distribution feature. In various exemplary embodiments, a feature rule corresponds to a profile text type feature that is based on text from a section(s) of a profile of a given member account. A profile text type feature can be a current job title feature, which is based on text from a current job title section of a given member account's profile. Returning to the Graphic Design service model example, the Classification Engine 206 identifies that the target member account's current job title contains a job title keyword(s) identified according to a current job title feature rule. Based on presence of the job title keyword(s), the Classification Engine 206 inserts a “1” value in a feature vector position assigned to the current job title feature rule. If the keyword is not present, the Classification Engine 206 insert a “0” value in the feature vector position assigned to the current job title feature rule.

The Classification Engine 206 calculates a similarity score between between 1 and 0 based on text similarity between the target member account's current job title and the job title keyword(s) of the current job title feature rule. The Classification Engine 206 inserts the similarity score at a feature vector position assigned to a current job title similarity feature rule. In addition, the job title keyword(s) has an assigned value of 0.8, which represents that the Classification Engine 206 has learned that 80% of member accounts that provide a graphic design service have the job title keyword(s) present in their profiles. If the target member account's current job title includes the job title keyword(s), the Classification Engine 206 inserts the value of 0.8 at a feature vector position assigned to a current job title keyword distribution feature rule.

Other profile text type features can be utilized by a service model as described above. Such text types include, but are not limited to, text or profile tags from profile text sections. Such text types are a previous job title(s), a current job function(s), a previous job function(s), a current industry(s), a previous industry(s), a profile summary keyword(s), a profile headline keyword(s), a current job description keyword(s), and previous job description keyword(s). Profile tags can be skills tag(s) explicitly selected by a member account.

Each service model 404, 410 . . . generates output 408, 414 by calculating a score. The score is a numerical value the represents a probability of whether the target member account provides a service that corresponds with a service model. A service identifier 416 of the Classification Engine 206 receives each output 408, 414 . . . . In an exemplary embodiment, the Classification Engine 206 compares each output 408, 414 to a threshold value. For example, if the output 408 meets or exceeds a first threshold value, the Classification Engine 206 infers the target member account represents a user who provides a type of service that corresponds with the first service model 404. The service identifier 416 classifies the type of service that corresponds with the first service model 404 as in inferred service 418 provided by the target member account. If the output 414 meets or exceeds a second threshold value, the Classification Engine 206 infers the target member account provides a type of service that corresponds with the second service model 410. The service identifier 416 also classifies the type of service that corresponds with the first service model 404 as in inferred service 418 provided by the target member account. In an alternative embodiment, the Classification Engine 206 ranks the outputs 408, 414 . . . . The Classification Engine 206 selects a portion (e.g. top 10%, top 5) of the ranked outputs as corresponding to an inferred service 418 offered by the target member account.

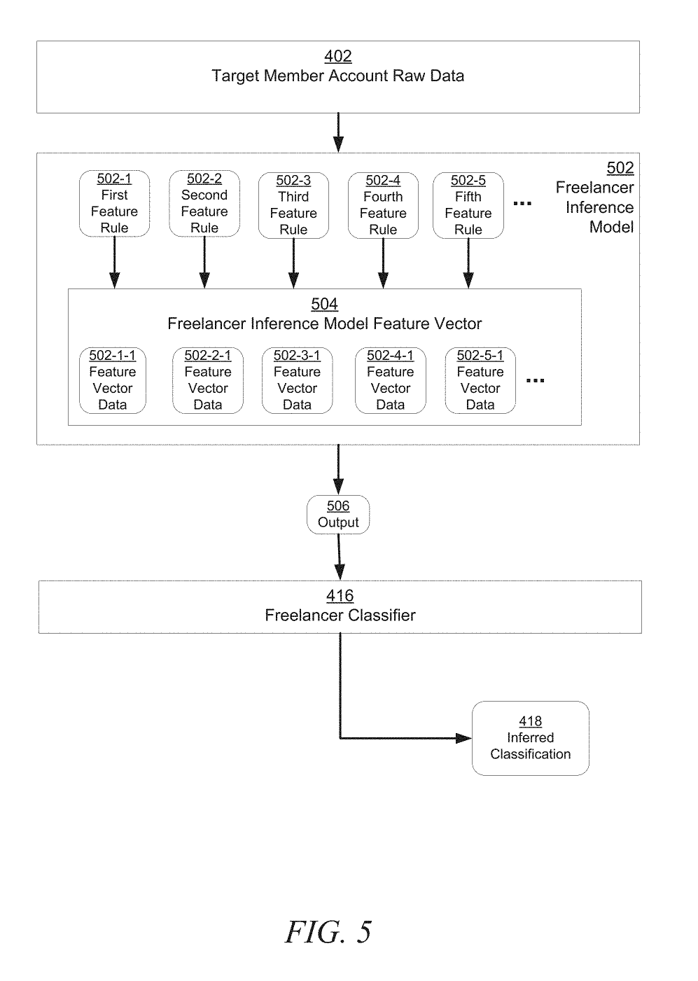

FIG. 5 illustrates a data flow diagram of a Classification Engine 206 assembling a feature vector 504 for a freelancer inference model 502 to classify the target member account as a freelancer account, according to various embodiments.

In addition to inferring the service(s) offered by the target member account (as well any specialties and skills), the Classification Engine 206 infers whether the target member account represents a user that provides a service(s) on a freelance basis. The Classification Engine 206 utilizes a set of pre-defined features of a freelancer inference model 502. The Classification Engine 206 assembles a feature vector 504 according to encoded freelancer inference model feature rules 502-1, 502-2, 502-3, 502-4, 502-5 . . . and a given member account's raw data 402. Each freelancer inference model feature rule 502-1, 502-2, 502-3, 502-4, 502-5 . . . transforms a portion of raw data 402 into feature vector data 502-1-1, 502-2-1, 502-3-1, 502-4-1, 502-5-1 . . . . The Classification Engine 206 inserts each feature vector data 502-1-1, 502-2-1, 502-3-1, 502-4-1, 502-5-1 . . . into a pre-defined feature vector position. It is understood that the freelancer inference model 502 is separate from any of the service models 404, 410 . . . .

Various type of pre-defined features are represented according to feature rules. Each feature rule has a corresponding regression coefficient. The freelancer inference model includes a profile completeness feature rule. The profile completeness feature rule is based on a measure of how many profile sections contain text and attributes. For example, the target member account's profile has 95% of its sections that have text or one or more attributes. The Classification Engine 206 has learned that member accounts that provide freelance services have at least 90% of their respective profiles complete. Since the target member account's profile completeness is over 90%, the Classification Engine 206 inserts a “1” value in a feature vector position assigned to the profile completeness feature rule. If a profile completeness is less than 90%, the Classification Engine 206 insert a “0” value in the feature vector position assigned to the profile completeness feature rule. In an alternative embodiment, the Classification Engine 206 inserts a 0.95 value in the feature vector position assigned to the profile completeness feature rule, where the 0.95 value is based on the target member account's profile being 95% complete.

The freelancer inference model includes recommendations feature rule. If the target member account's profile has a plurality of recommendations that meets a learned threshold number of recommendations (or endorsements from consumer accounts in the freelance marketplace), the Classification Engine 206 inserts a “1” value in a feature vector position assigned to the recommendations feature rule. If the learned threshold number of recommendations is not met, the Classification Engine 206 insert a “0” value in the feature vector position assigned to the recommendations feature rule. In an alternative embodiment, if the target member account's profile has 75 recommendations, the Classification Engine 206 transforms the number value of 75 to a score value between 0 and 1 and inserts that score value in the feature vector position assigned to the recommendations feature rule.

The freelancer inference model includes profile picture feature rule. If the target member account has a profile picture, the Classification Engine 206 inserts a “1” value in a feature vector position assigned to the profile picture feature rule. If no profile picture is present, the Classification Engine 206 insert a “0” value in the feature vector position assigned to the profile completeness feature rule.

The freelancer inference model includes a company industry feature rule. The company industry feature rule is based on text selected by a given member account for their profile. For example, the Classification Engine 206 has learned that member account's that provide freelance services are less prevalent in particular industries. A match between the target member account's company industry profile attribute and any of the learned particular industries thereby indicates that the target member account may not be a freelancer. Due to the match, the Classification Engine 206 inserts a “0” value in a feature vector position assigned to the company industry feature rule. If there is no match present, the Classification Engine 206 insert a “1” value in the feature vector position assigned to the company industry feature.

The Classification Engine 206 assembles the feature vector 504 in a similar manner with respect to a company size feature rule. For example, the Classification Engine 206 has learned that member account's that provide freelance services are less prevalent in companies of various sizes (such as corporations having more than 25 employees) Matching company size attributes between the target member account's profile and the learned company sizes results in the Classification Engine 206 inserting a “0” value in a feature vector position assigned to the company size feature rule. If there is no match present, the Classification Engine 206 insert a “1” value in the feature vector position assigned to the company size feature rule. In an alternative embodiment, the Classification Engine 206 transforms the number of employees value of 25 to a score value between 0 and 1 and inserts the score value in the feature vector position assigned to the company size feature rule.

The freelancer inference model 502 includes a social network activity feature rule. Such social network activity includes a frequency of logins, message activity and/or social network group memberships. The Classification Engine 206 learns various thresholds activity metrics for each type of social network activity. Such threshold activity metrics represent social network activity typical of a freelancer account. For example, a freelancer account typically logs in 4 times a day or 10 times a week, a freelancer account sends at least 20 messages in the social network per month, a freelancer account typically belongs to at least 4 groups. If the target member account's social network activity meets all (or a particular percentage) of the thresholds, the Classification Engine 206 inserts a “1” value in the feature vector position assigned to the social network activity feature rule. If the target member account's social network activity does not meet all (or the particular percentage) of the thresholds, the Classification Engine 206 insert a “0” value in the feature vector position assigned to the social network activity feature rule.

The freelancer inference model includes a marketplace browsing activity feature rule. The Classification Engine 206 accesses data representative of the target member account's browsing behaviours within the social network service. Such behaviours includes, for example, page views, link selections, providing ratings, providing recommendations, providing endorsements, accepting social network connection invitations, etc. The Classification Engine 206 detects the target member account's browsing behaviours include a plurality of views of portions of the freelance marketplace. If the plurality of views meets a learned threshold of views, the Classification Engine 206 inserts a “1” value in the feature vector position assigned to the marketplace browsing activity feature. If the learned threshold of views is not met, the Classification Engine 206 insert a “0” value in the feature vector position assigned to the marketplace browsing activity feature. In an alternative embodiment, the Classification Engine 206 transforms the target member account's browsing behaviour in the freelance marketplace into a score between 1 and 0 and inserts the score in the feature vector position assigned to the marketplace browsing activity feature rule. It is understood the Classification Engine 206 has learned thresholds for link selections, ratings, recommendations, endorsements, and acceptances of social network connection invitations as well.

The freelancer inference model 502 generates output 506 by calculating a score. The score is a numerical value the represents a probability of whether the target member account represent a user that provides a service(s) on a freelance basis. A freelancer classifier 416 of the Classification Engine 206 receives the output 506. The freelancer classifier 416 compares the output 506 to a freelance threshold value. If the output 506 meets or exceeds the freelance threshold value, the freelancer classifier 416 infers the target member account represents a user who provides a type of service(s) on a freelance basis. The freelancer classifier 416 generates an inferred classification 418 that classifies the target member account as a freelancer account. If the output 506 does not meet or exceed the freelance threshold value, the freelancer classifier 416 infers the target member account represents a user who does not provide a type of service(s) on a freelance basis. The freelancer classifier 416 generates an inferred classification 418 that classifies the target member account as a non-freelancer account.

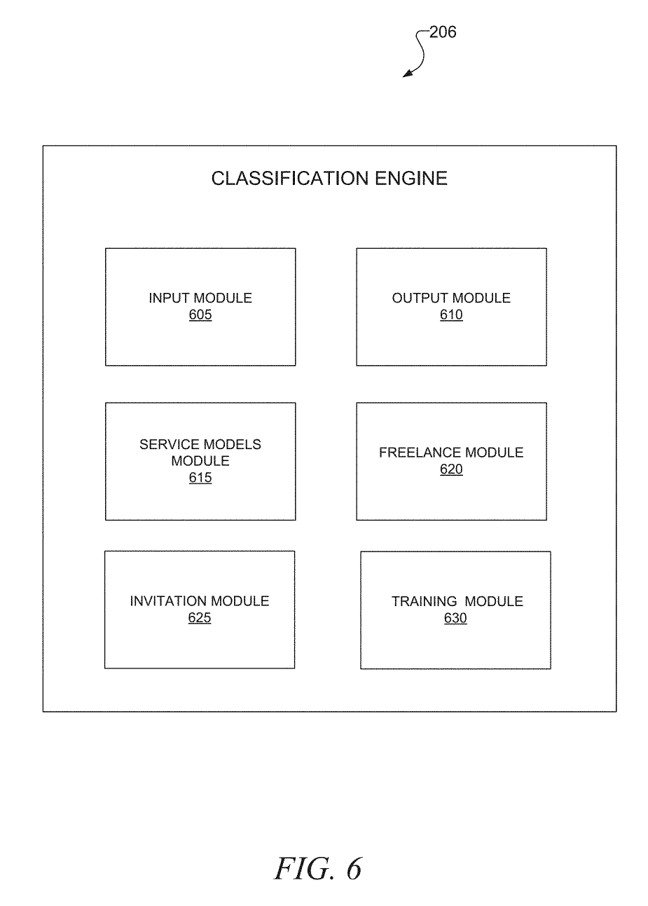

FIG. 6 is a block diagram showing example components of a Classification Engine 206, according to some embodiments. As shown in FIG. 6, the Classification Engine 206 includes an input module 605, output module 610, service models module 615, freelance module 620, marketplace module 625 and a training module 630.

The input module 605 is a hardware-implemented module that controls, manages and stores information related to any inputs from one or more components of system 102 as illustrated in FIG. 1 and FIG. 2. In various embodiments, the inputs include raw data of a target member account. Raw data includes at least a portion of one or more of: profile data, profile attributes, profile text, browsing history, browsing patterns, transaction history, marketplace browsing activity and the target member account's social graph.

The output module 610 is a hardware-implemented module that controls, manages and stores information related to which sends any outputs to one or more components of system 102 as illustrated in FIG. 1 and FIG. 2. In some embodiments, the output is generated from various service models and a freelancer inference model. The output is also an interred service and a freelancer classification. The output can also be an invitation to join a freelance marketplace, such as a message sent to the target member account.

The service models module 615 is a hardware-implemented module which manages, controls, stores, and accesses information related to inferring one or more services based on raw data of a target member account. For example, the service models module 615 includes one or more data structures representative of a plurality of service models used to infer a service based on raw account data of a target member account as described herein.

The freelance module 520 is a hardware-implemented module which manages, controls, stores, and accesses information related related to inferring whether the target member account is a freelancer account. For example, the freelance module 520 includes one or more data structures representative of a freelancer inference model to infer whether the target member account is a freelancer account as described herein.

The invitation module 525 is a hardware-implemented module which manages, controls, stores, and accesses information related to generating an invitation and sending the invitation to a target member account. For example, the invitation module 525 generates an invitation for a freelancer account and send the invitation in a message to the freelancer account.

The training module 630 is a hardware-implemented module which manages, controls, stores, and accesses information related to building and updating models of the Classification Engine 206. For example, the training module 630 utilizes logged historical data of various freelancer accounts and various member consumer accounts to identifies features for and to train each service model and the freelancer inference model. Training models can occur in an online or offline mode. In addition, the training module 630 updates the models based on model outputs and classifications.

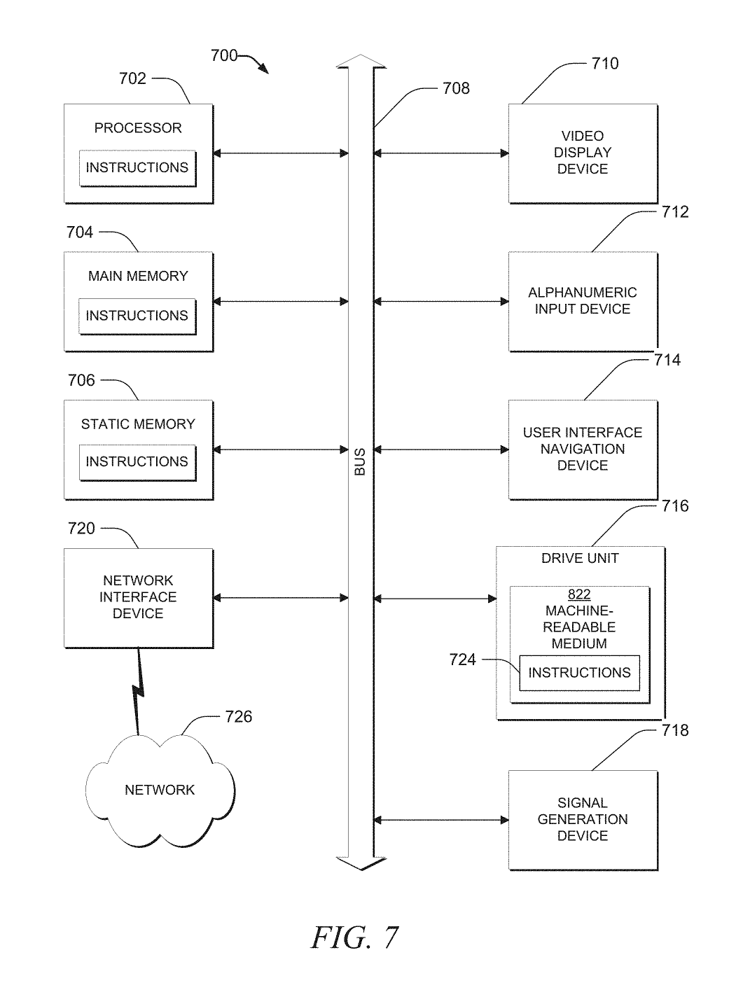

FIG. 7 is a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed') network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 700 includes a processor 702 (e.g., a central processing unit (CPU), a graphics processing unit (GPU) or both), a main memory 704, and a static memory 706, which communicate with each other via a bus 708. Computer system 700 may further include a video display device 710 (e.g., a liquid crystal display (LCD) or a cathode ray tube (CRT)). Computer system 700 also includes an alphanumeric input device 712 (e.g., a keyboard), a user interface (UI) navigation device 714 (e.g., a mouse or touch sensitive display), a disk drive unit 716, a signal generation device 718 (e.g., a speaker) and a network interface device 720.

Disk drive unit 716 includes a machine-readable medium 722 on which is stored one or more sets of instructions and data structures (e.g., software) 724 embodying or utilized by any one or more of the methodologies or functions described herein. Instructions 724 may also reside, completely or at least partially, within main memory 704, within static memory 706, and/or within processor 702 during execution thereof by computer system 700, main memory 704 and processor 702 also constituting machine-readable media.

While machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks,

Instructions 724 may further be transmitted or received over a communications network 726 using a transmission medium. Instructions 724 may be transmitted using network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer system, comprising:
a processor;
a memory device holding an instruction set executable on the processor to cause the computer system to perform operations comprising:
identifying, according to encoded rules of a plurality of service models, at least one type of service offered by a target member account of a social network service;
classifying, according to encoded rules of a freelancer inference model, the target member account as a freelancer account; and
sending an invitation to the freelancer account to join a freelance marketplace within the social network service, the freelance marketplace comprises at least one consumer account requesting to purchase a performance of the at least one type of service offered by the freelancer account.

2. The computer system as in claim 1, wherein identifying, according to encoded rules of a plurality of service models, at least one type of service offered by a target member account of a social network service comprises:
for each service model in the plurality of service models:
accessing encoded data representative of a feature rule for a type of pre-defined feature;
accessing encoded data representative of an attribute of the target member account that corresponds with the type of the pre-defined feature;
identifying a learned coefficient associated with the type of the pre-defined feature; and
assembling, according to the feature rule, a portion of feature vector data for the target member account based on the attribute of the target member account and the learned coefficient associated with the type of the pre-defined feature.

3. The computer system as in claim 2, further comprising:
wherein the feature rule comprises a profile text type feature rule;
wherein accessing encoded data representative of an attribute of a respective service account comprises: accessing encoded data representative of a type of profile text of the target member account;
wherein the learned coefficient is associated with a profile text type feature; and
wherein assembling, according to the feature rule, a portion of feature vector data comprises: assembling, according to the profile text type feature rule, a portion of feature vector data for the target member account based on the type of profile text of the target member account and the learned coefficient associated with the profile text type feature.

4. The computer system as in claim 3, further comprising:
wherein a profile text type feature rule comprises: a job description keyword feature rule;
wherein accessing encoded data representative of a type of profile text of the target member account comprises: identifying at least one keyword present in at least one job description in the profile of the target member account;
wherein the learned coefficient is associated with a job description keyword feature; and
wherein assembling, according to the profile text type feature rule, a portion of feature vector data comprises: assembling, according to the job description feature rule, a portion of feature vector data for the target member account based on the at least one keyword present in the at least one job description and the learned coefficient associated with the job description keyword feature.

5. The computer system as in claim 3, further comprising:
wherein a profile text type feature rule comprises: a skills feature rule;
wherein accessing encoded data representative of a type of profile text of the target member account comprises: identifying at least one skills descriptor tagged to the profile of the target member account by the target member account;
wherein the learned coefficient is associated with a skills feature; and
wherein assembling, according to the profile text type feature rule, a portion of feature vector data comprises: assembling, according to the skills feature rule, a portion of feature vector data for the target member account based on the at least one skills descriptor and the learned coefficient associated with the skills feature.

6. The computer system as in claim 3, further comprising:
wherein a profile text type feature rule comprises: a profile summary keyword feature rule;
wherein accessing encoded data representative of a type of profile text of the target member account comprises: identifying at least one keyword present in a summary section in the profile of the target member account;
wherein the learned coefficient is associated with a profile summary keyword feature; and
wherein assembling, according to the profile text type feature rule, a portion of feature vector data comprises: assembling, according to the profile summary keyword feature rule, a portion of feature vector data for the target member account based on the least one keyword present in the summary section and the learned coefficient associated with the profile summary keyword feature.

7. The computer system as in claim 1, wherein classifying, according to encoded rules of a freelancer inference model, the target member account as a freelancer account comprises:
accessing encoded data representative of a company size feature rule;
accessing encoded data representative of a company size attribute of the target member account;
identifying a learned coefficient associated with a company size feature; and
assembling, according to the company size feature rule, a portion of feature vector data for the target member account based on the company size attribute of the target member account and the learned coefficient associated with the company size feature.

8. The computer system as in claim 1, wherein classifying, according to encoded rules of a freelancer inference model, the target member account as a freelancer account comprises:
accessing encoded data representative of an industry feature rule;
accessing encoded data representative of an industry attribute of the target member account;
identifying a learned coefficient associated with an industry feature; and
assembling, according to the industry feature rule, a portion of feature vector data for the target member account based on the industry attribute of the target member account and the learned coefficient associated with the industry feature.

9. The computer system as in claim 1, wherein classifying, according to encoded rules of a freelancer inference model, the target member account as a freelancer account comprises:
accessing encoded data representative of an marketplace interest feature rule;
accessing encoded data representative of previous freelance marketplace browsing activity of the target member account;
identifying a learned coefficient associated with a marketplace interest feature; and
assembling, according to the industry feature rule, a portion of feature vector data for the target member account based on the previous freelance marketplace browsing activity and the learned coefficient associated with the marketplace interest feature.

10. A computer-implemented method, comprising:
identifying, according to encoded rules of a plurality of service models, at least one type of service offered by a target member account of a social network service;
classifying, according to encoded rules of a freelancer inference model, the target member account as a freelancer account; and
sending an invitation to the freelancer account to join a freelance marketplace within the social network service, the freelance marketplace comprises at least one consumer account requesting to purchase a performance of the at least one type of service offered by the freelancer account.

11. The computer-implemented method as in claim 10, wherein identifying, according to encoded rules of a plurality of service models, at least one type of service offered by a target member account of a social network service comprises:
for each service model in the plurality of service models:
accessing encoded data representative of a feature rule for a type of pre-defined feature;
accessing encoded data representative of an attribute of the target member account that corresponds with the type of the pre-defined feature;
identifying a learned coefficient associated with the type of the pre-defined feature; and
assembling, according to the feature rule, a portion of feature vector data for the target member account based on the attribute of the target member account and the learned coefficient associated with the type of the pre-defined feature.

12. The computer-implemented method as in claim 11, further comprising:
wherein the feature rule comprises a profile text type feature rule;
wherein accessing encoded data representative of an attribute of a respective service account comprises: accessing encoded data representative of a type of profile text of the target member account;
wherein the learned coefficient is associated with a profile text type feature; and
wherein assembling, according to the feature rule, a portion of feature vector data comprises: assembling, according to the profile text type feature rule, a portion of feature vector data for the target member account based on the type of profile text of the target member account and the learned coefficient associated with the profile text type feature.

13. The computer-implemented method as in claim 12, further comprising:
wherein a profile text type feature rule comprises: a job description keyword feature rifle;
wherein accessing encoded data representative of a type of profile text of the target member account comprises: identifying at least one keyword present in at least one job description in the profile of the target member account;
wherein the learned coefficient is associated with a job description keyword feature; and
wherein assembling, according to the profile text type feature rule, a portion of feature vector data comprises: assembling, according to the job description feature rule, a portion of feature vector data for the target member account based on the at least one keyword present in the at least one job description and the learned coefficient associated with the job description keyword feature.

14. The computer-implemented method as in claim 12, further comprising:
wherein a profile text type feature rule comprises: a skills feature rule;
wherein accessing encoded data representative of a type of profile text of the target member account comprises: identifying at least one skills descriptor tagged to the profile of the target member account by the target member account;
wherein the learned coefficient is associated with a skills feature; and
wherein assembling, according to the profile text type feature rule, a portion of feature vector data comprises: assembling, according to the skills feature rule, a portion of feature vector data for the target member account based on the at least one skills descriptor and the learned coefficient associated with the skills feature.

15. The computer-implemented method as in claim 12, further comprising:
wherein a profile text type feature rule comprises: a profile summary keyword feature rule;
wherein accessing encoded data representative of a type of profile text of the target member account comprises: identifying at least one keyword present in a summary section in the profile of the target member account;
wherein the learned coefficient is associated with a profile summary keyword feature; and
wherein assembling, according to the profile text type feature rule, a portion of feature vector data comprises: assembling, according to the profile summary keyword feature rule, a portion of feature vector data for the target member account based on the least one keyword present in the summary section and the learned coefficient associated with the profile summary keyword feature.

16. The computer-implemented method as in claim 10, wherein classifying, according to encoded rules of a freelancer inference model, the target member account as a freelancer account comprises:
accessing encoded data representative of a company size feature rule;
accessing encoded data representative of a company size attribute of the target member account;
identifying a learned coefficient associated with a company size feature; and
assembling, according to the company size feature rule, a portion of feature vector data for the target member account based on the company size attribute of the target member account and the learned coefficient associated with the company size feature.

17. The computer-implemented method as in claim 10, wherein classifying, according to encoded rules of a freelancer inference model, the target member account as a freelancer account comprises:
accessing encoded data representative of an industry feature rule;
accessing encoded data representative of an industry attribute of the target member account;
identifying a learned coefficient associated with an industry feature; and
assembling, according to the industry feature ride, a portion of feature vector data for the target member account based on the industry attribute of the target member account and the learned coefficient associated with the industry feature.

18. The computer-implemented method as in claim 10, wherein classifying, according to encoded rules of a freelancer inference model, the target member account as a freelancer account comprises:
accessing encoded data representative of an marketplace interest feature rule;
accessing encoded data representative of previous freelance marketplace browsing activity of the target member account;
identifying a learned coefficient associated with a marketplace interest feature; and
assembling, according to the industry feature rule, a portion of feature vector data for the target member account based on the previous freelance marketplace browsing activity and the learned coefficient associated with the marketplace interest feature.

19. A non-transitory computer-readable medium storing executable instructions thereon, which, when executed by a processor, cause the processor to perform operations including:
identifying, according to encoded rules of a plurality of service models, at least one type of service offered by a target member account of a social network service;
classifying, according to encoded rules of a freelancer inference model, the target member account as a freelancer account; and
sending an invitation to the freelancer account to join a freelance marketplace within the social network service, the freelance marketplace comprises at least one consumer account requesting to purchase a performance of the at least one type of service offered by the freelancer account.

20. The non-transitory computer-readable medium as in claim 19, wherein classifying, according to encoded rules of a freelancer inference model, the target member account as a freelancer account comprises:
accessing encoded data representative of an marketplace interest feature rule;
accessing encoded data representative of previous freelance marketplace browsing activity of the target member account;
identifying a learned coefficient associated with a marketplace interest feature; and
assembling, according to the industry feature rule, a portion of feature vector data for the target member account based on the previous freelance marketplace browsing activity and the learned coefficient associated with the marketplace interest feature.
